(19) United States
(12) Patent Application Publication
(10) Pub. No.: US 2009/0074172 A1
(43) Pub. Date: Mar. 19, 2009

(54) Information Processing Apparatus, Telephone Exchange Apparatus and Information Writing Control Method

(75) Inventors: Motohisa Araki, Akishima-shi (JP); Shuichi Sato, Sagamihara-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/202,994

(22) Filed: Sep. 2, 2008

(30) Foreign Application Priority Data
Sep. 13, 2007 (JP) 2007-238365

(51) Int. Cl. H04M 7/00

(52) U.S. Cl. 379/219

(57) ABSTRACT

According to one embodiment, an information processing apparatus includes a recorder which temporarily holds the processed information of the file in a buffer including a storage capacity smaller than storage capacity of the storage device during file processing, and a controller which transfers the processed information of the file recorded in the buffer to the storage device to write the processed information therein, when the amount of the processed information to be stored in the buffer reaches the maximum storage capacity of the buffer or when the processing of the file ends.

### CROSS-REFERENCE TO RELATED APPLICATIONS

This application is based upon and claims the benefit of priority from Japanese Patent Application No. 2007-238365, filed Sep. 13, 2007, the entire contents of which are incorporated herein by reference.

### BACKGROUND

1. Field

One embodiment of the present invention relates to an information processing apparatus which writes processed information in a storage device where the number of information writing times is limited, an information writing control method, and a telephone exchange apparatus which executes exchange processing among a plurality of telephone terminals.

2. Description of the Related Art

A telephone exchange apparatus can record, as long information, exchanged messages and the contents of the messages during the operation of call processing and maintenance of software. The log information is stored in a storage device of the telephone exchange apparatus. A time stamp is imparted to the format of a log, so that the contents can be deciphered by a manual or the like. The log is held for a long time to a certain degree.

It is to be noted that when a nonvolatile semiconductor memory disk is used as the storage device and a CPU requests the writing in the nonvolatile semiconductor memory disk, writing data is stored in a cache memory, and written back for each module of one track in an appropriate period (see Jpn. Pat. Appln. KOKAI Publication No. 2001-318832).

In addition, with the miniaturization of the telephone exchange apparatus, a flash memory such as a compact flash memory or a universal serial bus (USB) memory is sometimes used in the storage device. This flash memory has merits of miniaturization, high-speed access and the like, but there are restrictions on the number of deleting or writing times. Therefore, when the memory is used as the storage device and the writing and deleting are frequently performed, the life of the storage device might largely be shortened.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the constitution of a telephone exchange system according to a first embodiment of this invention;

FIG. 2 is a block diagram showing the constitution of the software for a CPU, an RAM, a storage device and a hard disk drive shown in FIG. 1;

FIG. 3 is a diagram showing one example of a storage type distinguishing table disposed in an operation system shown in FIG. 2;

FIG. 4 is a diagram showing one example of a writing information table stored in the RAM shown in FIG. 2;

FIG. 5 is a diagram showing one example of a threshold value setting table stored in the RAM shown in FIG. 2;

FIG. 6 is a flow chart showing the control processing procedure of the CPU in the first embodiment; and

FIG. 7 is a flow chart showing the control processing procedure of a CPU in a second embodiment of this invention.

### DETAILED DESCRIPTION

Various embodiments according to the invention will be described hereinafter with reference to the accompanying drawings, in general, according to one embodiment of the invention, An information processing apparatus which writes processed information for each file to be processed in a storage device in which the number of information writing times is limited to a predetermined number, the information processing apparatus comprising: a recorder which temporarily holds the processed information of the file in a buffer including a storage capacity smaller than storage capacity of the storage device during file processing; and a controller which transfers the processed information of the file recorded in the buffer to the storage device to write the processed information therein, when the amount of the processed information to be stored in the buffer reaches the maximum storage capacity of the buffer or when the processing of the file ends.

### First Embodiment

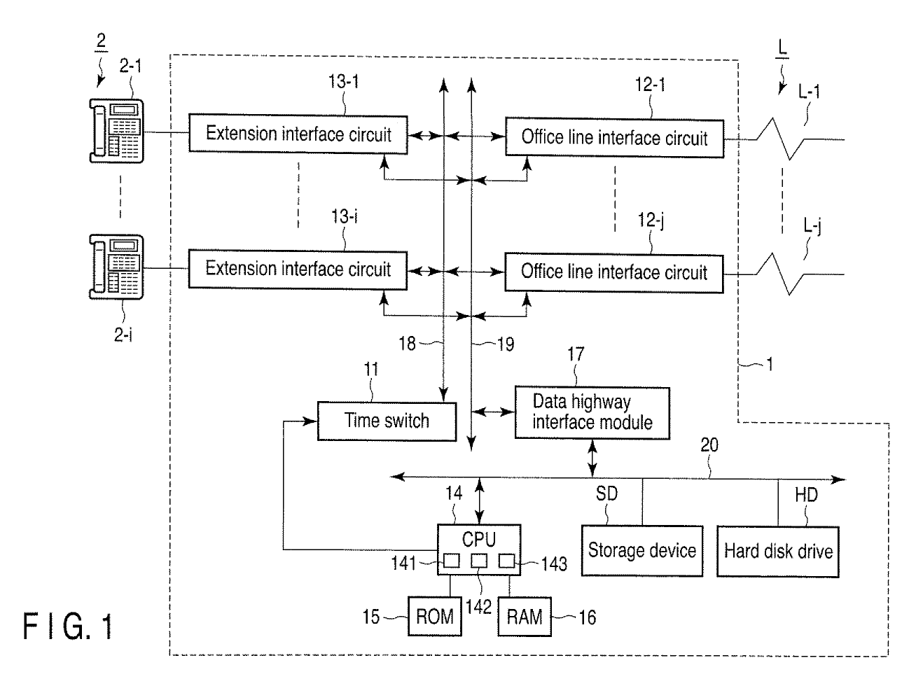

FIG. 1 is a block diagram showing the constitution of a telephone exchange system according to a first embodiment of this invention.

As shown in the drawing, this telephone exchange system is constituted by arbitrarily connecting a plurality of (i at maximum) extension terminals 2 (2-1 to 2-i) to a telephone exchange apparatus 1. It is to be noted that as the extension terminal 2, an analog telephone set, a digital key telephone set or the like is used.

The telephone exchange apparatus 1 further includes a time switch 11, a plurality of (j) office line interface circuits 12 (12-1 to 12-j), a plurality of (i) extension interface circuits 13 (13-1 to 13-i), a central processing module (CPU) 14, a read only memory (ROM) 15, a random access memory (RAM) 16, a data highway interface module 17, a storage device SD, and a hard disk drive HD. The time switch 11, the office line interface circuit 12 and the extension interface circuit 13 are connected to one another via a PCM highway 18.

Moreover, the office line interface circuit 12, the extension interface circuit 13 and the data highway interface module 17 are connected to one another via a data highway 19. Furthermore, the CPU 14, the data highway interface module 17, the storage device SD and the hard disk drive HD are connected to one another via a CPU bus 20. It is to be noted that the time switch 11 is directly connected to the CPU 14.

The time switch 11 does the switching of time slots on the PCM highway 18 based on the control of the CPU 14, to arbitrarily exchange and connect the office line interface circuits 12 and the extension interface circuits 13.

The office line interface circuits 12 are connected to office lines L (L-1 to L-j) such as a public line and an exclusive use line if necessary. The office line interface circuit 12 performs a office line interface operation concerning the connected office line L. Moreover, the office line interface circuit 12 transmits to and receives from the CPU 14 various pieces of control information on the office line interface operation via the data highway 19, the data highway interface module 17 and the CPU bus 20.

The extension interface circuit 13 is connected to the extension terminal 2 if necessary. The extension interface circuit 13 performs an extension interface operation concerning the connected extension terminal 2. Moreover, the extension interface circuit 13 transmits to and receives from the CPU 14 various pieces of control information on the extension interface operation via the data highway 19, the data highway interface module 17 and the CPU bus 20.

The CPU 14 performs processing based on an operation program stored in the ROM 15 to generally control the time switch 11, the office line interface circuit 12 and the extension interface circuit 13, thereby realizing the operation of the telephone exchange apparatus 1.

The RAM 16 is a memory for temporarily storing the processed data (a message, a protocol stack, call processing data and a system management log) by control processing of the CPU 14, and has a storage capacity of, for example, 64 Mbytes. The processed data include data necessary for maintenance, for example, the operation history data of the extension terminal 2 or history data on call processing.

The storage device SD is a memory such as a flash memory or a USB memory in which the number of information writing or deleting times is limited, and has a storage capacity of, for example, 2 Gbytes, 4 Gbytes or so.

The hard disk drive HD has a storage capacity of 100 Gbytes or so.

Additionally, in this first embodiment, the CPU 14 includes a processed data holding module 141, a table creating module 142 and a processed data transferring control module 143. The processed data holding module 141 temporarily holds, in the RAM 16, the processed data of a file for each application program that is being operated.

The table creating module 142 creates a management table indicating a correspondence relation between the application program which is being operated and the file. The processed data transferring control module 143 refers to a management table in accordance with predetermined conditions, and stores, in the storage device SD, the processed data of the file corresponding to the application program which is being operated on the RAM 16, based on the reference result.

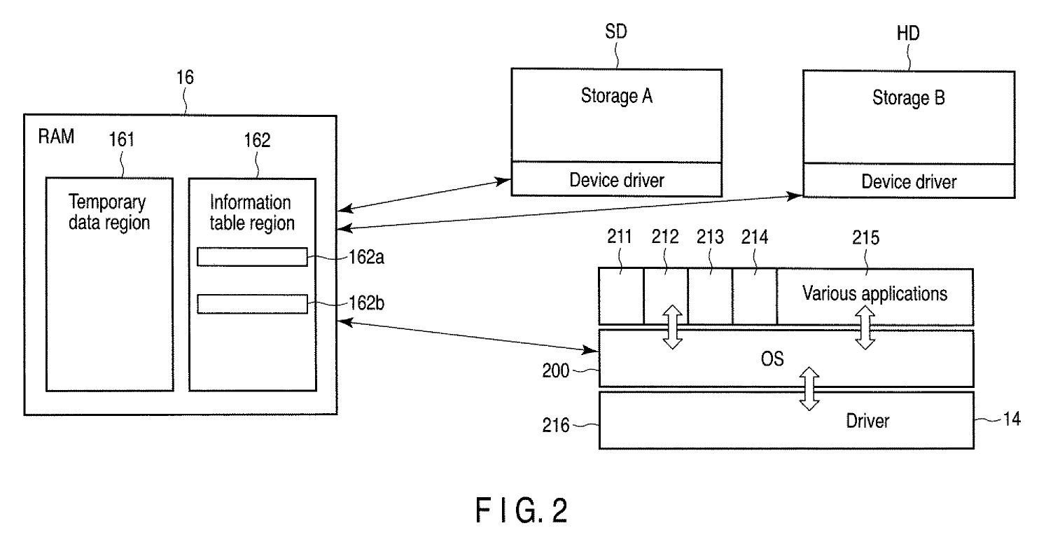

FIG. 2 is a block diagram showing the constitution of the software for the CPU 14, the RAM 16, the storage device SD and the hard disk drive HD described above.

The CPU 14 includes a general-purpose operating system (OS) 200, and also includes a plurality of application programs to be executed on this OS 200. This application program is constituted of a program group for exchange processing and a group 215 of various programs. The program group 215 executes communication management processing such as charging or communication history data management, another general clerical processing and the like. The program group for the exchange processing is constituted of a call processing terminal control program 211, a call processing group control program 212, a call processing service control program 213 and a maintenance program 214.

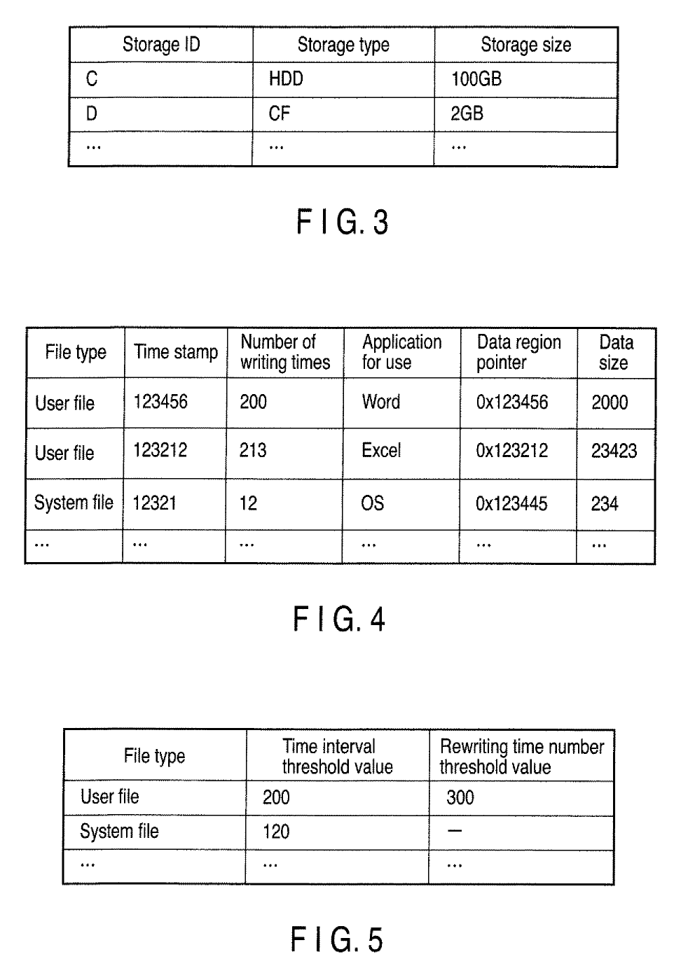

Moreover, as shown in FIG. 3, the OS 200 is provided with a storage type distinguishing table in which a storage ID, a storage type and a storage size are associated with one another.

Furthermore, the CPU 14 includes a driver 216. This driver 216 is software which drives an interface between the driver and the CPU bus 20.

On the RAM 16, an information table region 162 and a data region 161 in which data is temporarily held are secured. The data region 161 and the information table region 162 can be accessed by the OS 200, the storage device SD and the hard disk drive HD, respectively.

Moreover, the information table region 162 is provided with a writing information table l62a and a threshold value setting table 162b created by the table creating module 142. In the writing information table l62a, as shown in FIG. 4, a time stamp during writing, the number of writing times, a file type and an application type are managed, and are linked with data written in a temporary data region.

In the threshold value setting table 162b, as shown in FIG. 5, there are stored data which indicate corresponding relations among the file type, the threshold value of a time interval and the threshold value of the number of rewriting times is stored.

Next, the operation of the system having the above constitution will be described.

It is now assumed that a call to a public line is made in the extension terminal 2-1. Then, an off-hook operation in the extension terminal 2-1 is analyzed by the extension interface circuit 13-1, and an off-hook signal is transferred from this extension interface circuit 13-1 to the CPU 14 via the data highway 19, the data highway interface module 17 and the CPU bus 20.

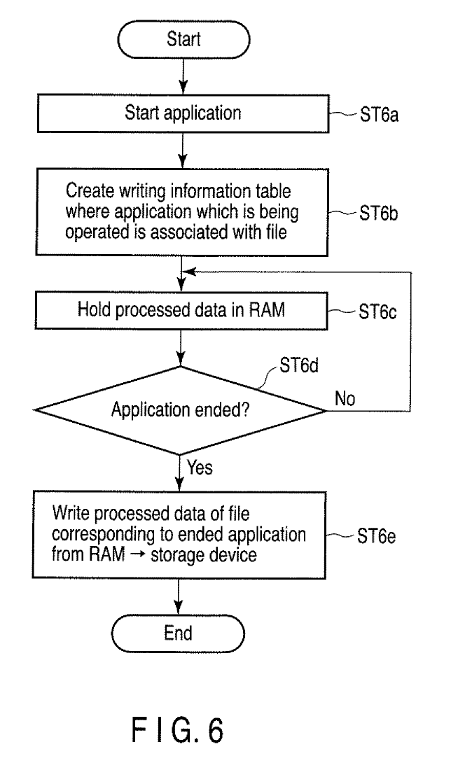

When this off-hook signal is transferred, the CPU 14 executes control processing shown in FIG. 6. First, the CPU 14 starts the application program necessary for the processing (block ST6a). Here, to process the off-hook signal of the extension terminal 2-1, the call processing terminal control program 211 is started, and terminal processing for the extension terminal 2-1 is executed by this program 211.

At this time, the CPU 14 creates the writing information table 162a in which the call processing terminal control program 211 is associated with a file name (a system file), stores the thus created table in the information table region 162 of the RAM 16 (block ST6b), and holds a control signal as the processed data corresponding to the call processing terminal control program 211 in the data region 161 of the RAM 16 (block ST6c).

That is, when group processing is necessary, the processing is requested from the call processing terminal control program 211 to the call processing group control program 212. Moreover, when mutual connection between terminals is necessary, the processing is requested from the call processing group control program 212 to the call processing service control program 213. Then, in this call processing service control program 213, the CPU 14 transfers, to the time switch 11, a signal for sending a dial tone to the extension terminal 2-1 which has made the call, and transfers, to the extension interface circuit 13-1, a control signal for allowing acceptance of a dial signal. At this time, the CPU 14 creates the writing information table 162a in which the call processing service control program 213 is associated with the file name (the system file), stores the table in the information table region 162 of the RAM 16, and holds the control signal corresponding to the call processing service control program 213 in the data region 161 of the RAM 16.

On receiving the control signal, the extension interface circuit 13-1 sends the dial tone from the time switch 11 to the extension terminal 2-1 as a transmitter, and then becomes a state for receiving the dial signal from the extension terminal 2-1.

In this state, when a user of the extension terminal 2-1 who has confirmed the dial tone performs a dial operation, the dial signal is sent to the extension interface circuit 13-1, and analyzed in this circuit. Then, this analyzed dial signal is transferred from the extension interface circuit 13-1 to the CPU 14 via the data highway 19.

Then, the CPU 14 analyzes a call destination from the dial signal. When it is seen that the call destination is the public network, the CPU 14 generates a control signal for connecting an analog trunk by the call processing service control program 213, and transfers this control signal to the office line interface circuit 12-1 via the data highway 19. The office line interface circuit 12-1 which has received this control signal captures the office line L-1 to send the dial signal to the public network, and waits for response from the public network.

Subsequently, in a case where the public network notifies the office line interface circuit 12-1 that the call destination has hooked off, the office line interface circuit 12-1 transfers a control signal indicating this effect to the CPU 14 via the data highway 19, the data highway interface module 17 and the CPU bus 20. On receiving this control signal, the CPU 14 generates a request for connecting a communication path. This request is transferred to the time switch 11. Then, the time switch 11 executes processing for connecting the communication path between the extension interface circuit 13-1 as the transmitter and the office line interface circuit 12-1.

Thus, talking between the extension terminal 2-1 as the transmitter and a telephone set of a talking partner connected to the public network becomes possible.

Subsequently, in a state in which the talking between the extension terminal 2-1 and the telephone set of the talking partner is performed, the user of the extension terminal 2-1 performs an on-hook operation to end the talking. Then, the on-hook signal is transferred from the extension interface circuit 13-1 to the CPU 14 via the data highway 19, the data highway interface module 17 and the CPU bus 20. On receiving the on-hook signal, the CPU 14 performs disconnection processing of the communication path, and shifts from block ST6d to block ST6e where the CPU reads, from the RAM 16, control signals corresponding to the call processing terminal control program 211 and the call processing service control program 213 to be ended, respectively, while referring to the writing information table 162a, to write the signals in the storage device SD.

It is to be noted that in the above processing, an example has been described in which the control signal corresponding to the application program held in the RAM 16 is written in the storage device SD at the end of the application program. However, in addition, conditions on which a file as the control signal is written in the storage device SD are set as follows.

A case where the time stamp described in the writing information table 162a is referred and predetermined time or more elapses.

A case where the number of the writing times described in the writing information table 162a is referred and the predetermined number of times or more passes.

A case where a file close command is received from the OS 200.

A case where the amount of information to be recorded reaches the maximum storage capacity of the RAM 16.

A case where the OS 200 ends.

Moreover, as the conditions during the writing in the storage device SD, the threshold value setting table 162b of FIG. 5 is set, and this table 162b is changed by the user, whereby the writing timing can be changed to a timing desired by the user. Furthermore, threshold values can separately be set in accordance with the type of the file, and a timing to write the message can be changed for each type of file. In addition, a single condition such as an only time interval or the number of rewriting times only, or a combination of a plurality of conditions can be set to writing conditions.

Furthermore, a storage device SD region of a system file for use in the OS 200 and a file region for use in user data can periodically be switched. This operation is performed to switch the system file region in which rewriting does not frequently occur and a user region in which the rewriting comparatively frequently occurs, whereby a storage region can uniformly be used.

As described above, according to the first embodiment, the CPU 14 temporarily holds, in the data region of the RAM 16, the control signals to be processed by the call processing terminal control program 211 and the call processing service control program 213 as the files during the starting of the call processing terminal control program 211 and the call processing service control program 213; creates the writing information table 162a in which the call processing terminal control program 211 and the call processing service control program 213 are associated with the file names; and writes, in the storage device SD, the files which correspond to the call processing terminal control program 211 and the call processing service control program 213, respectively, and which are held in the RAM 16 while referring to the writing information table 162a during the ending of the call processing terminal control program 211 and the call processing service control program 213.

Therefore, the number of the generation times of unnecessary writing and deleting in the storage device SD can be decreased to lengthen the life of the storage device SD as compared with a conventional example.

Moreover, in the above first embodiment, even when the OS 200 is ended during the overflow of the RAM 16, hardware failure, or version upgrading, the file recorded in the RAM 16 can be read and written in the storage device SD. Therefore, the number of the generation times of the unnecessary writing or deleting in the storage device SD can be decreased. In consequence, the life of the storage device SD can be lengthened as compared with the conventional example.

### Second Embodiment

In a second embodiment of this invention, a file is also written in a hard disk drive HO.

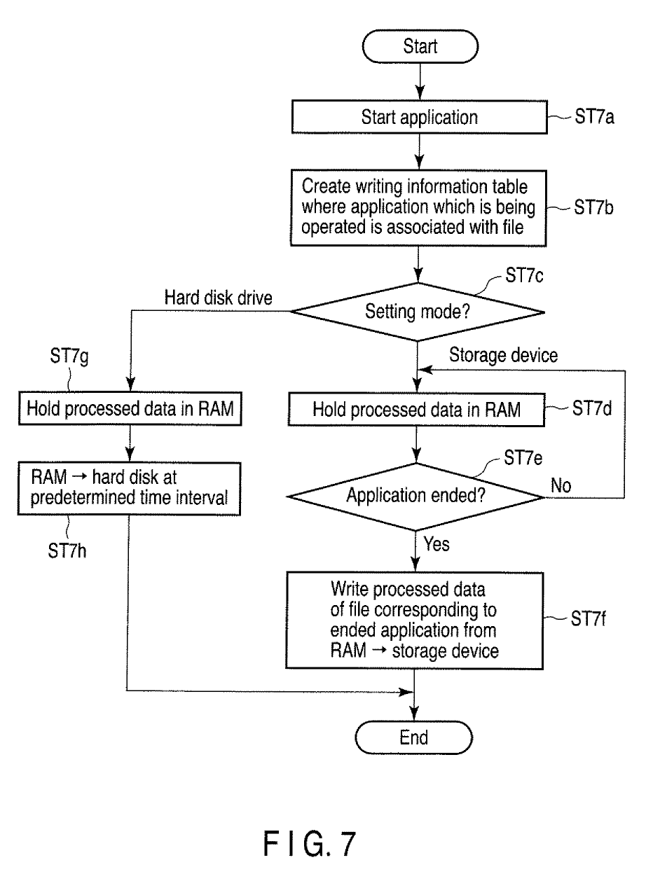

On receiving an off-hook signal, a CPU 14 executes control processing shown in FIG. 7. First, the CPU 14 starts an application program necessary for the processing (block ST7a). Here, the off-hook signal of an extension terminal 2-1 is transferred to start a call processing terminal control program 211, and terminal processing for the extension terminal 2-1 is executed by this program 211.

At this time, the CPU 14 creates a writing information table 162a in which the call processing terminal control program 211 is associated with a file name (a system file), stores the table in an information table region 162 of an RAM 16 (block ST7b), and judges whether or not a setting mode is a writing mode to a storage device SD or a writing mode to the hard disk drive HD (block ST7c).

Here, when it is judged that the setting mode is the writing mode to the storage device SD, the CPU 14 holds a control signal as processed data corresponding to the call processing terminal control program 211 in a data region 161 of the RAM 16 (block ST7d). Then, to end the call processing terminal control program 211, the CPU 14 shifts from block ST7e to block ST7f where the CPU reads, from the RAM 16, the control signal corresponding to the call processing terminal control program 211 to be ended while referring to the writing information table 162a, to write the signal in the storage device SO.

On the other hand, when it is judged in the block ST7c that the setting mode is the writing mode to the hard disk drive HD, the CPU 14 holds the control signal as the processed data corresponding to the call processing terminal control program 211 in the data region 161 of the RAM 16 (block ST7g). Then, the CPU reads, from the RAM 16, the control signal corresponding to the call processing terminal control program 211 to write the signal in the hard disk drive HD at a predetermined time interval (block ST7h).

As described above, in the above second embodiment, the writing mode is set to, for example, each application program or each file which is used. Consequently, in the case of a certain file, the file recorded in the RAM 16 is transferred to the storage device SD and written therein, at the end of the application program which is being operated. On the other hand, in the case of a file for another application program, the file recorded in the RAM 16 is transferred to and written in the hard disk drive HD at a predetermined time interval. Thus, optimum file recording processing for each application program or each file can be performed.

### Other Embodiment

This invention is not limited to the above embodiments. For example, in the above embodiments, a telephone exchange apparatus has been described as an example, but this invention may be applied to an information processing apparatus such as a personal computer, or a system including a CPU for controlling a storage device, and a general-purpose OS.

In addition, the constitution of the telephone exchange apparatus, the type of the storage device, the software constitution of the CPU, the type of the general-purpose OS, a control procedure of writing of a file in the storage device, the contents of the procedure and the like may variously be modified and implemented without departing from the scope of this invention.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus which writes processed information for each file to be processed in a storage device in which the number of information writing times is limited to a predetermined number, the information processing apparatus comprising:
a recorder which temporarily holds the processed information of the file in a buffer including a storage capacity smaller than storage capacity of the storage device during file processing; and
a controller which transfers the processed information of the file recorded in the buffer to the storage device to write the processed information therein, when the amount of the processed information to be stored in the buffer reaches the maximum storage capacity of the buffer or when the processing of the file ends.

2. The information processing apparatus according to claim 1, further comprising:
a creator which creates a management table indicating a correspondence relation between an application and the file at a time, when the file is processed for each application,
wherein the controller refers to the management table at the end of the application, and transfers the processed information of the file corresponding to the application in the buffer to the storage device based on reference result of the management table, to write the processed information in the storage device.

3. The information processing apparatus according to claim 2, wherein the controller transfers the processed information of the file recorded in the buffer to the storage device to write the processed information therein, at the end of an operating system to execute the plurality of applications.

4. The Information processing apparatus according to claim 1, further comprising:
another storage apparatus which is different from the storage device and in which the number of the information writing times is not limited,
wherein the controller includes:
a first mode in which the controller transfers the processed information of the file recorded in the buffer to the storage device to write the processed information therein, when the amount of the processed information to be stored in the buffer reaches the maximum storage capacity of the buffer or when the processing of the file ends;
a second mode in which the controller transfers the processed information of the file recorded in the buffer to the another storage apparatus to write the processed information therein at a predetermined time interval; and
a select controller which selectively executes the first mode and the second mode in accordance with a mode designating operation.

5. A telephone exchange apparatus which executes exchange processing among a plurality of telephone terminals and which writes processed information of each file on the exchange processing in a storage device in which the number of information writing times is limited to a predetermined number, the telephone exchange apparatus comprising:
a recorder which temporarily holds the processed information of the file in a buffer including a storage capacity smaller than storage capacity of the storage device during file processing; and
a controller which transfers the processed information of the file recorded in the buffer to the storage device to write the processed information therein, when the amount of the processed information to be stored in the buffer reaches the maximum storage capacity of the buffer or when the processing of the file ends.

6. The telephone exchange apparatus according to claim 5, further comprising:
a creator which creates a management table indicating a correspondence relation between an application and the file at a time, when the file is processed for each application,
wherein the controller refers to the management table at the end of the application, and transfers the processed information of the file corresponding to the application in the buffer to the storage device based on reference result of the management table, to write the processed information in the storage device.

7. The telephone exchange apparatus according to claim 6, wherein the controller transfers the processed information of the file recorded in the buffer to the storage device, to write the processed information therein, at the end of an operating system to execute the plurality of applications.

8. The telephone exchange apparatus according to claim 5, further comprising:
another storage apparatus which is different from the storage device and in which the number of the information writing times is not limited
wherein the controller includes:
a first mode in which the controller transfers the processed information of the file recorded in the buffer to the storage device to write the processed information therein, when the amount of the processed information to be stored in the buffer reaches the maximum storage capacity of the buffer or when the processing of the file ends;
a second mode in which the controller transfers the processed information of the file recorded in the buffer to the another storage apparatus to write the processed information therein at a predetermined time interval; and
a select controller which selectively executes the first mode and the second mode in accordance with a mode designating operation.

9. An information writing control method in which processed information for each file to be processed is written in a storage device in which the number of information writing times is limited to a predetermined number, the method comprising:
temporarily holding the processed information of the file in a buffer including a storage capacity smaller than that of the storage device during file processing; and
transferring the processed information of the file recorded in the buffer to the storage device to write the processed information therein, when the amount of the processed information to be stored in the buffer reaches the maximum storage capacity of the buffer or when the processing of the file ends.
